(19) United States
(12) Patent Application Publication
(10) Pub. No.: US 2023/0133991 A1
(43) Pub. Date: May 4, 2023

(54) Display Control Device, Method and Apparatus

(71) Applicants: Haining ESWIN IC Design Co., Ltd., Haining (CN); Beijing ESWIN Computing Technology Co., Ltd., Beijing (CN)

(72) Inventor: Weijie ZHAO, Haining (CN)

(21) Appl. No.: 18/148,391

(22) Filed: Dec. 29, 2022

(30) Foreign Application Priority Data
May 27, 2022 (CN) 202210588572.0

(51) Int. Cl. G09G 3/20; G09G 3/36

(52) U.S. Cl. CPC G09G 3/2092; G09G 3/3611; G09G 2330/021; G09G 2370/00; G09G 2320/0252

(57) ABSTRACT

The present application discloses a display control device, method and apparatus, and relates to the technical field of displays. The device of the present application comprises: a determination unit for determining a plurality of display point positions having a same display parameter from data to be displayed, the data to be displayed comprising a plurality of display point positions and the display parameter corresponding to each of the display point positions; an acquisition unit for acquiring the display parameter and a plurality of display point positions; and a control unit for controlling the display driving chip to perform a display control operation according to the display parameter at the plurality of display point positions, so that the display driving chip does not need to acquire the data to be displayed in real time during the display control operation.

### CROSS REFERENCE OF RELATED APPLICATION

This application claims priority to Chinese Patent Application No. 2022105885720 titled “DISPLAY CONTROL DEVICE, METHOD AND APPARATUS” and filed to the China National Intellectual Property Administration, the entire contents of which are incorporated herein by reference.

### TECHNICAL FIELD

The present application relates to the field of display technology, and more particularly to a display control device, method and apparatus.

### BACKGROUND ART

With the continuous progress of technology, electronic apparatus is gradually towards the direction of environmental protection and energy conservation. In particular, in the field of display technology, more and more manufacturers have identified reducing power consumption as the main direction of research and development. Generally, in the process of displaying an image, control of a display screen is often realized on the basis of communication between a video card, a screen driving board and a display driving chip. That is, in the above-mentioned chip interaction process, there is also a problem of occupying the power consumption of the apparatus.

In some cases, there are cases where the display screen is not changed, and in order to reduce power consumption in the display control process, this is often achieved by reducing communication between the video card and the screen driver board. However, as users are increasingly sensitive to power consumption problems, especially in a scenario where a notebook is not powered on, the current display control method still has the problem of high power consumption. Therefore, how to further reduce the power consumption of a display control process has become an increasingly important problem to a person skilled in the art.

### SUMMARY OF THE INVENTION

Embodiments of the present application provide a display control device, method and apparatus, and a main object thereof is to reduce power consumption in a display control process.

In order to solve the above-mentioned technical problem, the embodiments of the present application provide the following technical solutions.

In a first aspect, the present application provides a display control device comprising:

a determination unit for determining a plurality of display point positions having a same display parameter from data to be displayed, the data to be displayed comprising the plurality of display point positions and the display parameter corresponding to each of the display point positions; an acquisition unit for acquiring the display parameter and the plurality of display point positions; and

a control unit for controlling a display driving chip to perform a display control operation according to the display parameter at the plurality of display point positions, so that the display driving chip does not need to acquire the data to be displayed in real time during the display control operation.

Optionally, the determination unit is specifically used for acquiring the data to be displayed from a video card, and determining the display point positions having the same display parameter in an adjacent area in a target pattern from the data to be displayed.

Optionally, the determination unit comprises: a first determination module or a second determination module,

the first determination module being arranged in a screen logic board for, when the video card indicates that the data to be displayed exists, requesting the data to be displayed from the video card, and determining the display point positions having the same display parameter in the adjacent area in the target pattern from the data to be displayed; and

the second determination module being provided in the video card for, when it is detected that the video card indicates that the data to be displayed exists, acquiring the data to be displayed, and determining the display point positions having the same display parameter in the adjacent area in the target pattern from the data to be displayed.

Optionally, the target pattern comprises a row or column; and the adjacent area comprises an adjacent row or an adjacent column,

the first determination module also specifically comprising: a first determination submodule or a second determination submodule,

the first determination submodule being used for, when the target pattern is a row and the adjacent area is an adjacent row, determining the plurality of display point positions having the same display parameter from the data to be displayed from adjacent rows by rows; and

the second determination submodule being used for, when the target pattern is a column and the adjacent area is an adjacent column, determining the plurality of display point positions having the same display parameter from the data to be displayed from adjacent columns by columns.

Optionally, the acquisition unit is arranged on the screen logic board, and is further used for packaging the display parameter and the plurality of display point positions to obtain display control data, and transmitting the display control data to the control unit; and

the control unit is further used for receiving the display control data, parsing the display control data into the display parameter and the plurality of display point positions, and controlling the display driving chip to display sequentially at the plurality of display point positions on the basis of the display parameter.

Optionally, the control unit is provided to the display driving chip,

the control unit being further used for, after acquiring the display parameter, determining a starting point position and an ending point position at the plurality of display point positions, retaining the display parameter in a preset memory area, and outputting a signal adjustment command to the display driving chip according to the starting point position and the ending point position; and the signal adjustment command being used for controlling the display driving chip to adjust from a first level to a second level from the starting point position until the second level is restored to the first level after display from the starting point position to the ending point position according to the display parameter in the preset memory area.

Optionally, the device further comprises:

a transmission adjustment unit used for determining a display interval between each frame of images from the display driving chip, and transmitting the display interval to the acquisition unit, the display interval being used for characterizing a time interval from a last one of the display point positions in an m frame of image to a first one of the display point positions in an m+1 frame of image displayed by a display apparatus, and m being a positive integer,

the acquisition unit being further configured to transmit the display control data to the control unit on the basis of the display interval.

In a second aspect, the present application also provides a display control method comprising:

determining a plurality of display point positions having a same display parameter from data to be displayed, the data to be displayed comprising the plurality of display point positions and the display parameter corresponding to each of the display point positions;

acquiring the display parameter and the plurality of display point positions; and

controlling a display driving chip to perform a display control operation according to the display parameter at the plurality of display point positions, so that the display driving chip does not need to acquire the data to be displayed in real time during the display control operation.

Optionally, the determining a plurality of display point positions having a same display parameter from data to be displayed comprises:

acquiring the data to be displayed from a video card, and determining the display point positions having the same display parameter in an adjacent area in a target pattern from the data to be displayed.

Optionally, the determining the display point positions having the same display parameter in an adjacent area in a target pattern from the data to be displayed comprises:

when the video card indicates that the data to be displayed exists, requesting the data to be displayed from the video card, and determining the display point positions having the same display parameter in the adjacent area in the target pattern from the data to be displayed;

or

when it is detected that the video card indicates that the data to be displayed exists, acquiring the data to be displayed, and determining the display point positions having the same display parameter in the adjacent area in the target pattern from the data to be displayed.

Optionally, the target pattern comprises a row or column; and the adjacent area comprises an adjacent row or an adjacent column,

when the video card indicates that the data to be displayed exists, requesting the data to be displayed from the video card, and determining the display point positions having the same display parameter in the adjacent area in the target pattern from the data to be displayed comprises:

when the target pattern is a row and the adjacent area is an adjacent row, determining the plurality of display point positions having the same display parameter from the data to be displayed from adjacent rows by rows; and

when the target pattern is a column and the adjacent area is an adjacent column, determining the plurality of display point positions having the same display parameter from the data to be displayed from adjacent columns by columns.

Optionally, the acquiring the display parameter and the plurality of display point positions comprises:

packaging the display parameter and the plurality of display point positions to obtain display control data, and transmitting the display control data to the control unit; and

the controlling a display driving chip to perform a display control operation according to the display parameter at the plurality of display point positions comprises:

receiving the display control data, parsing the display control data into the display parameter and the plurality of display point positions, and controlling the display driving chip to display sequentially at the plurality of display point positions on the basis of the display parameter.

Optionally, the receiving the receiving the display control data, parsing the display control data into the display parameter and the plurality of display point positions, and controlling the display driving chip to display sequentially at the plurality of display point positions on the basis of the display parameter comprises:

after acquiring the display parameter, determining a starting point position and an ending point position in the plurality of display point positions, retaining the display parameter in a preset memory area, and outputting a signal adjustment command to the display driving chip according to the starting point position and the ending point position; and

the signal adjustment command being used for controlling the display driving chip to adjust from a first level to a second level from the starting point position until the second level is restored to the first level after display from the starting point position to the ending point position according to the display parameter in the preset memory area.

Optionally, the method further comprises:

determining a display interval between each frame of images from the display driving chip, the display interval being used for characterizing a time interval from a last one of the display point positions in an m frame of image to a first one of the display point positions in an m+1 frame of image displayed by a display apparatus, and m being a positive integer; and

transmitting the display control data on the basis of the display interval.

In a third aspect, the present application also provides a display control apparatus, the apparatus comprising a memory medium; and one or more processors, the memory medium being coupled to the processors, the processors being configured to execute program instructions stored in the memory medium, the program instructions when executed performing the display control method of any one of the first aspects.

With the above-mentioned technical solution, the technical solution provided by the present application has at least the following advantages.

The present application provides a display control device, method and apparatus. The present application can determine a plurality of display point positions having the same display parameter from data to be displayed by a determination unit, then acquire the display parameter and the plurality of display point positions by an acquisition unit, and finally control a display driving chip to perform a display control operation according to the display parameter at the plurality of display point positions by a control unit. The data to be displayed can be acquired from the video card, and the data to be displayed comprises a plurality of display point positions and a display parameter corresponding to each of the display point positions, that is to say, the display driving chip does not need to acquire the data to be displayed in real time during a display control operation, which ensures that in the process of subsequent display control, the display control function can be realized only by means of the display driving chip itself, without any communication and interaction with the video card or even the screen logic board, so that when there are a plurality of display point positions having the same display parameter in the data to be displayed, there is no need for the above-mentioned communication interaction process among the video card, the screen logic board and the display driving chip. Since the control unit can directly perform display control on the basis of the acquired display parameter and display point positions in the display control process, the communication channel among the screen logic board, the video card and the display driving chip can be closed, thereby reducing the power consumption influence caused by the communication interaction, especially when there are more display point positions having the same display parameter in the data to be displayed, the power consumption occupation situation caused by the communication interaction can be greatly reduced. The effect of reducing power consumption in the display control process is achieved.

The above-mentioned description is merely an overview of the technical solution of the present application, which can be implemented according to the contents of the description in order to enable the technical means of the present application to be more clearly understood, and in order to enable the above-mentioned and other objects, features and advantages of the present application to be more clearly understood, particular embodiments of the present application are set forth below.

### BRIEF DESCRIPTION OF THE DRAWINGS

The above-mentioned and other objects, features and advantages of exemplary embodiments of the present application will be readily understood by reading the following detailed description with reference to the accompanying drawings. Embodiments of the present application are illustrated by way of example, and not by way of limitation, in the figures of the accompanying drawings and in which like reference numerals refer to similar or corresponding parts.

FIG. 1 is a block diagram showing a constitution of a display control device according to an embodiment of the present application.

FIG. 1-A shows a principle schematic diagram of a conventional display control process and a principle schematic diagram of a display control device in a display control process according to an embodiment of the present application.

FIG. 2 is a block diagram showing a constitution of another display control device according to an embodiment of the present application.

FIG. 3 is a schematic diagram showing specific steps in the operation of a display control device according to an embodiment of the present application.

FIG. 4 is a schematic diagram showing specific steps in the operation of a display control device according to an embodiment of the present application.

FIG. 5 shows a flowchart of a display control method provided by an embodiment of the present application.

### DETAILED DESCRIPTION OF THE INVENTION

Exemplary embodiments of the present application will be described in more detail below with reference to the accompanying drawings. While the drawings show exemplary embodiments of the present application, it should be understood that the application may be embodied in various forms and should not be construed as limited to the embodiments set forth herein. Rather, these embodiments are provided so that this disclosure will be thorough and complete, and will fully convey the scope of the disclosure to those skilled in the art.

It should be noted that, unless otherwise indicated, technical or scientific terms used herein shall have the ordinary meaning as understood by one of ordinary skill in the art to which this application belongs.

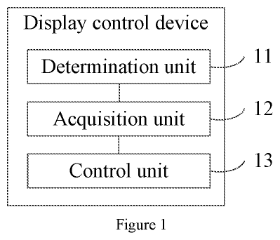

An embodiment of the present application provides a block diagram of a display control device, as shown in FIG. 1, the display control device comprising:

A determination unit 11 which can be used for determining a plurality of display point positions having the same display parameter from data to be displayed, wherein the data to be displayed comprises the plurality of display point positions and the display parameter corresponding to each of the display point positions;

an acquisition unit 12 which can be used for acquiring the display parameter and the plurality of display point positions; and

a control unit 13 which can be used for controlling the display driving chip to perform a display control operation according to the display parameter at the plurality of display point positions, so that the display driving chip does not need to acquire the data to be displayed in real time during the display control operation.

Generally, a display is composed of contents or elements displayed by a plurality of display point positions therein in the process of displaying an image, that is to say, a picture such as an image and text which we usually see is actually formed by combining the contents or elements displayed by the display point positions. In this case, then, there may be a case where a plurality of display point positions in the picture in the display display the same content or element, for example, when all white pictures are displayed in the entire display screen, the content displayed by each display point position in the display is the same white pixel block.

Herein, the display parameter in the present embodiment can be understood to be a corresponding parameter when the display point position realizes the content or element displayed in the display, and the display parameter can be understood to be obtained by processing of.

In practical applications, in order to realize a display effect in a screen, an existing display control process generally needs to be realized by three parties of a video card, a screen logic board and a display control chip communicating with each other, and is specifically shown in FIG. 1-A, wherein GPU is a video card, (graphics processing unit), also known as the display core, the visual processor, and the display, which is a designed to perform image and graphics related operations on personal computers, workstations, gaming machines, and some electronic devices (e.g. smart phones, etc.). The screen logic board can be a Tcon, namely, a timing control module, wherein the Tcon is also called a screen driving board and a central control board, and the main function of the Tcon is to process an image data input signal (the input signal containing three types of signals, namely, an RGB data signal, a clock signal and a control signal) sent from a video card GPU during a display process, convert same into a signal capable of driving a liquid crystal screen, and then directly transmit same to a receiving chip of the liquid crystal screen, such as a display driving chip Driver IC, so as to realize a control function of the display process. In addition, the display driving chip, namely Driver IC, is the main control part of the display screen imaging system, in which the components such as resistor, regulator, comparator and power transistor are integrated, and generally comprises a liquid crystal display module and a display subsystem, which are mainly responsible for the functions such as driving the display and controlling the driving current. That is, the display driving chip is a control chip that generates a level signal applied to the imaging unit during imaging of the display or display apparatus. In the existing display control process, after the data to be displayed is generated in the GPU, real-time interactive communication is sent to the Tcon, and then the Tcon processes the data to be displayed into a display control signal which can be recognized by the Driver IC according to the time sequence logic and transmits same, and the Driver IC generates a corresponding level signal after receiving the display control signal and acts on the imaging unit to perform display control. Therefore, in the existing display control process, the communication among the GPU-Tcon-Driver IC is interactive in real time, which generates a lot of power consumption. In contrast, the idea of the present embodiment is that after acquiring the display point positions having the same display parameter in the data to be displayed, the Driver IC can be directly controlled to generate a level signal corresponding to the display parameter only according to these display point positions, that is to say, in the display control process, the display parameter and these display point positions having the same display parameter are sent to the Driver IC by the Tcon only on the basis of one-time interactive communication, and the whole display control process is followed up. The Driver IC itself uses these display point positions and display parameter for display, which eliminates the need for real-time interaction among GPU-Tcon-Driver IC in the whole display control process, until these display point positions with the same display parameter are displayed, and the Driver IC can perform display control by itself. On such basis, in the embodiment of the present application, when image display control is required, it is first determined by the determination unit how many display point positions in the data to be displayed corresponding to the image to be displayed have the same contents, that is, which display point positions have the same display parameter.

In addition, it should be noted that in the embodiments of the present application, the display point position may be understood as a minimum imaging unit included in a display or a display apparatus, such as a pixel point, and may also be a display unit or a display array composed of a minimum display unit, and the specific form of the display point position is not limited herein and may be determined on the basis of the imaging unit of the display or the display apparatus.

When the determination unit determines that there are a plurality of display point positions having the same display parameter, it is explained that there are different positions in a picture to be displayed by a subsequent display or display apparatus to display the same content or element, for example, the entire display or display apparatus shows a white picture. At this time, the acquisition unit may record and acquire the display point positions having the same display parameter for subsequent display control on the basis of the display point positions and the display parameter.

In addition, in the process of acquiring the display parameter and the display point positions, the acquisition unit can directly acquire data to be displayed from the video card via one-time communication, that is to say, only communication interaction with the video card needs to be performed at one time, so that the problem of response delay in the display control process caused by multiple batch acquisitions in the subsequent display control process can be avoided.

After the acquisition unit acquires the plurality of display point positions with the same display parameter, the control unit may directly use these display point positions and display parameter to control the display driving chip to perform display control, and the specific control process may be generating corresponding level signals according to the display parameter at the plurality of display point positions, and acting on the imaging device on the basis of the level signals so as to realize the display control operation.

It should be noted that, in the process of performing the display control operation on the basis of the display parameter, the corresponding level signal is generated in the same manner as the conventional level signal is generated, and the process of acting on the imaging device to obtain the corresponding image is also consistent with the conventional imaging method, which will not be described in detail herein.

The embodiments of the present application provide a display control method, and the present application can determine a plurality of display point positions having a same display parameter from data to be displayed by a determination unit, then acquire the display parameter and the plurality of display point positions by an acquisition unit, and finally control a display driving chip to perform a display control operation according to the display parameter at the plurality of display point positions by a control unit. The data to be displayed can be acquired from the video card, and the data to be displayed comprises a plurality of display point positions and a display parameter corresponding to each of the display point positions, that is to say, the display driving chip does not need to acquire the data to be displayed in real time during a display control operation, which ensures that in the process of subsequent display control, the display control function can be realized only by means of the display driving chip itself, without any communication and interaction with the video card or even the screen logic board, so that when there are a plurality of display point positions of the same display parameter in the data to be displayed, there is no need for the above-mentioned communication interaction process among the video card, the screen logic board and the display driving chip, and since the control unit can directly perform display control on the basis of the acquired display parameter and display point positions in the display control process, the communication channel among the screen logic board, the video card and the display driving chip can be closed, thereby reducing the power consumption influence caused by the communication interaction, especially when there are more display point positions with the same display parameter in the data to be displayed. The power consumption occupation situation caused by the communication interaction can be greatly reduced. The effect of reducing power consumption in the display control process is achieved.

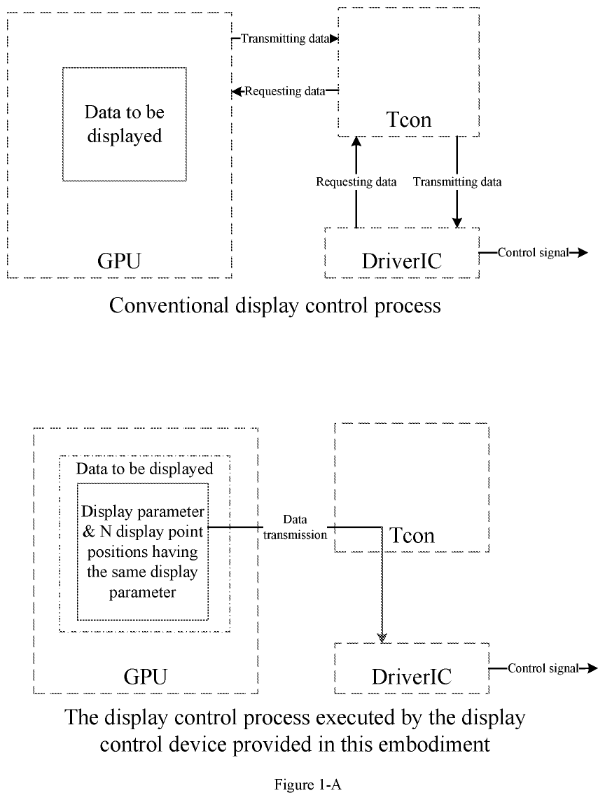

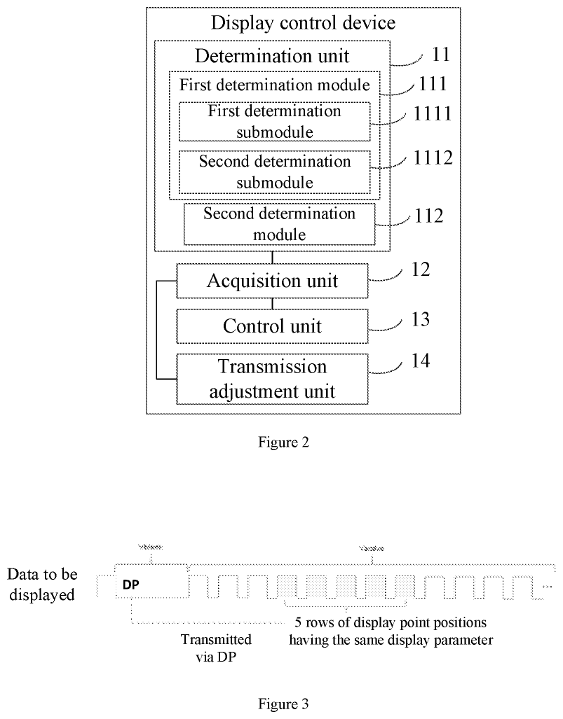

In some embodiments, as shown in FIG. 2, the determination unit 11 may be specifically used for acquiring the data to be displayed from the video card, and determining the display point positions with the same display parameter in adjacent area in a target pattern from the data to be displayed.

In this way, in determining a plurality of display point positions with the same display parameter, the determination can be performed in a manner of adjacent positions or regions, and on the basis of the imaging characteristics of the display apparatus, when the video card generates data to be displayed, the data between the display point positions of adjacent area are adjacent in sequence, which enables the confirmation to be performed more quickly when determining whether there is a display point position with the same display parameter between the display point positions of adjacent area in a target pattern, thereby making the determination process faster.

In some embodiments, as shown in FIG. 2, the determination unit 11 comprises: a first determination module 111 or a second determination module 112.

The first determination module 111 is arranged in a screen logic board and can be used for, when the video card indicates that the data to be displayed exists, requesting the data to be displayed from the video card, and determining the display point positions having the same display parameter in the adjacent area from the data to be displayed in a target pattern.

The second determination module 112 is provided in the video card and can be used for, when it is detected that the video card indicates that the data to be displayed exists, acquiring the data to be displayed, and determining the display point positions having the same display parameter the an adjacent area in a target pattern from the data to be displayed.

In the present embodiment, since the determination unit is in different application scenarios, the setting methods thereof are different. For example, the determination unit can be respectively set in a screen logic board or a video card, namely, two setting methods of a first determination module and a second determination module in the embodiment of the present application, wherein when the first determination module is set in the screen logic board, when there is data needing to realize a display effect subsequently, namely, data to be displayed, the data to be displayed is acquired by means of requesting data from the video card so as to determine the plurality of display point positions having the same display parameter therefrom. Thus, in the subsequent display control process, it is no longer necessary to request the display parameter of each display point in real time from the video card, thereby reducing the problem of large power consumption caused by real-time communication between the screen logic board and the video card.

On the other hand, when the second determination module is provided on the video card, when determining the data to be displayed, the data can be directly obtained locally from the video card and the plurality of display point positions having the same display parameter can be determined therefrom. In this way, the acquisition of the data to be displayed can be performed locally directly by means of the video card, and the efficiency of the determination unit acquiring the data to be displayed in the process of determining the plurality of display point positions having the same display parameter can be improved, thereby improving the execution efficiency of the whole scheme.

In some embodiments, as shown in FIG. 2, the target pattern comprises a row or column, and the adjacent area comprises an adjacent row or an adjacent column;

The first determination module 111 also specifically comprises: a first determination submodule 1111 or a second determination submodule 1111.

The first determination submodule 1111 can be used for, when the target pattern is a row and the adjacent area is an adjacent row, determining the plurality of display point positions with the same display parameter from the data to be displayed from adjacent rows by rows.

The second determination submodule 1111 can be used for determining the plurality of display point positions having the same display parameter from the data to be displayed from adjacent columns by columns when the target pattern is a column and the adjacent area is an adjacent column.

In the present embodiment, since the target pattern can be divided into two types, i.e. rows or columns, then there are two manners respectively corresponding to the corresponding rows and columns or adjacent columns, and the first determination module in the determination unit can respectively perform according to the following two aspects, specifically as follows.

On the one hand, when the target pattern is a row and the adjacent area is an adjacent row, a first determination submodule may determine the plurality of display point positions having the same display parameter from the data to be displayed in rows from adjacent rows.

The imaging method on the basis of the current display apparatus generally displays the display point positions of each row in sequence by means of a row, and therefore, in the present embodiment, whether the plurality of display point positions between two adjacent rows have the same display parameter is respectively judged by means of a row, thereby realizing the judgement of a plurality of display point positions with the same display parameter by means of a row.

For example, it is assumed that the display apparatus comprises three successively adjacent rows of display point positions of a third row, a fourth row and a fifth row, wherein each row respectively comprises 10 display point positions, the 10 display point positions of the third row are being respectively denoted as R1 to R10, and R1 to R10 corresponding to the same display parameter a1, the display point positions of the fourth line being respectively denoted as S1 to S10, and S1 to S10 corresponding to the same display parameter a2, the display point positions of the fifth row being denoted T1 to T10, respectively, and T1 to T10 corresponding to the same display parameter a3. Then, in the present embodiment, when it is judged whether the display point positions have the same display parameter, it may be firstly determined whether the display parameter a1 corresponding to the third rows R1 to R10 is the same as the display parameter a2 corresponding to the fourth rows S1 to S10 by rows, and then it is judged whether the display parameter a2 corresponding to the fourth rows S1 to S10 is the same as the display parameter a3 corresponding to the fifth rows T1 to T10, and the judgment result is given to determine the display point positions having the same display parameter. If the display parameter a1 is different from the display parameter a2, however, when the display parameter a2 is the same as the display parameter a3, it can be determined that the display point positions S1 to S10 and the display point positions T1 to T10 are the plurality of display point positions having the same display parameter. On the other hand, when the target pattern is a column and the adjacent area is an adjacent column, the first determination module can make a judgement on the basis of the columns, that is to say, determining in which columns the display point positions have the same display parameter from adjacent columns by columns.

On the basis of this, in the present embodiment, from the data to be displayed, the display point positions having the same display parameter in the adjacent area are determined in the target pattern, and when executed, it can be specifically as follows.

From the data to be displayed, the plurality of display point positions having the same display parameter are determined from adjacent columns in columns.

On the basis of the above-mentioned two execution modes of the first determination module, the first determination module described in the embodiment of the present application can ensure that, when determining the display point positions having the same display parameter, the imaging mode of the display apparatus can be determined in a row or column manner, respectively, so as to ensure that the imaging characteristic of the display apparatus is satisfied in the process of subsequent display control, thereby ensuring the accuracy of the display control effect. At the same time, since the first determination module can make determination on the basis of adjacent rows or adjacent columns, it can also ensure that the determination can be performed in a certain order during the determination of the display point positions having the same display parameter, avoiding the deviation of the subsequent display control effect caused by the disorder of the order, thereby improving the accuracy of the display control effect.

In some embodiments, as shown in FIG. 2, the acquisition unit 12, which is arranged on the screen logic board, can also be used for packaging the display parameter and the plurality of display point positions to obtain display control data, and transmitting the display control data to the control unit 13.

On the basis of this, the control unit 13 can also be used for receiving the display control data, parsing the display control data into the display parameter and the plurality of display point positions, and controlling the display driving chip to display sequentially at the plurality of display point positions on the basis of the display parameter.

Specifically, in the present embodiment, the transmission process may be performed using a preset protocol, which may be a BT protocol or a P2P protocol. Among them, P2P protocol, also known as P2P network transmission protocol, is short for peer-to-peer transmission, also known as “point-to-point”. “Peer-to-peer” technology is a new network technology, which is a communication mode that does not rely on the center to achieve direct transmission between each node or end.

BT protocol (Bit Torrent, BT protocol for short) is a communication protocol widely used in peer-to-peer network communication, which can quickly and massively realize data transmission, and is a common transmission communication protocol.

In the embodiment of the present application, the display parameter and the corresponding plurality of display point positions are packaged to obtain display control data, so that transmission can be performed in the manner of the display control data in subsequent transmission, so that after the acquisition unit acquires the display parameter and the display point positions, the problem of data loss which may be caused by the transmission process can be reduced while ensuring the transmission efficiency. At the same time, transmission through the preset protocol can effectively improve the transmission efficiency and reduce the time consumption problem caused by the transmission process.

In some embodiments, as shown in FIG. 2, the control unit 13 is provided on the display driving chip.

The control unit 13 can also be used for, after acquiring a display parameter, determining a starting point position and an ending point position in the plurality of display point positions, retaining the display parameter in a preset memory area, and outputting a signal adjustment command to the display driving chip according to the starting point position and the ending point position.

The signal adjustment command can be used for controlling the display driving chip to adjust from a first level to a second level from the starting point position until the second level is restored to the first level after display from the starting point position to the ending point position according to the display parameter in the preset memory area.

In the present embodiment, the signal adjustment command can be understood as an instruction for controlling the display of the display driving chip. Since the display driving chip actually controls the imaging device on the basis of the level form, in the present embodiment, directly on the basis of the signal adjustment command, the display driving chip can directly realize the display control of the same display effect of the plurality of display point positions after the starting point by changing the level directly at the first point of the plurality of display point positions, namely, the starting point. That is to say, under the action of the signal adjustment command, the display driving chip can directly change the level shape thereof on the basis of the display parameter in the preset memory area, so as to realize that a plurality of display point positions all having the same display parameter from the starting point position to the ending point position display the same display effect. The device described in the present embodiment is provided with all the units described in the embodiment of the first aspect, that is to say, it can also reduce the interaction process between the screen logic board and the display driving chip, and is also provided with the functions of the above-mentioned units or modules in the present embodiment, which can not only reduce the power consumption of the interaction process between the screen logic board and the display driving chip, but can also improve the display effect in the display control process, at the same time, achieving the direct control of the level signal of the display driving chip, and improving the control efficiency.

In some embodiments, as shown in FIG. 2, the device further comprises:

a transmission adjustment unit 14, which can be used for determining a display interval between each frame of images from the display driving chip, and transmitting the display interval to the acquisition unit 12, wherein the display interval can be used for characterizing a time interval from a last one of the display point positions in an m frame of image to a first one of the display point positions in an (m+1)th frame of image displayed by a display apparatus, wherein m is a positive integer;

The acquisition unit 12 may also be arranged to transmit the display control data to the control unit 13 on the basis of the display interval.

In the field of display technology, the general display apparatus usually uses an imaging method similar to the old-fashioned cathode ray tube in the process of image display, i.e. is scanned from the upper left end of the screen row by row. When the bottom line is scanned, namely, when a frame of image is displayed, it is necessary to return to the top line. When returning to the starting position of the top line of the screen, it takes a little time, which is called Vblank, namely, the display interval in the present embodiment. At the same time, with regard to the time period between the display intervals, the display period corresponds to a display period Vactive, wherein the display period is a light line scanning from a starting position of the uppermost line to a final position of the lowermost line in the screen, and this process is the display process of one frame of image, that is to say, the display process of each frame of image is composed of both the display period that is called Vactive and the display interval that is called Vblank.

Specifically, in the present embodiment, the operation process on the basis of the transmission adjustment unit and the acquisition unit can be as shown in FIG. 3 below. After acquiring a row of display point positions with the same display parameter, namely, a plurality of display point positions and display parameter from a GPU (video card), then packaging is performed to obtain display control data, and transmitting the display control data to the screen logic board via a DP line, wherein the screen logic board is Tcon. Then the display control data is transmitted to a Driver IC, namely, a display driving chip, on the basis of the screen logic board. The transmission is performed in the display interval during the transmission. Thus, the Tcon can output corresponding display control data to the Driver IC in time during the Vblank, and at the same time, when the same line of data is transmitted, the Tcon data transmission and the Tcon self-receiving data circuit can be cut off, and the Driver IC can also detect the display control data of the Tcon to perform self-refresh output of data in time.

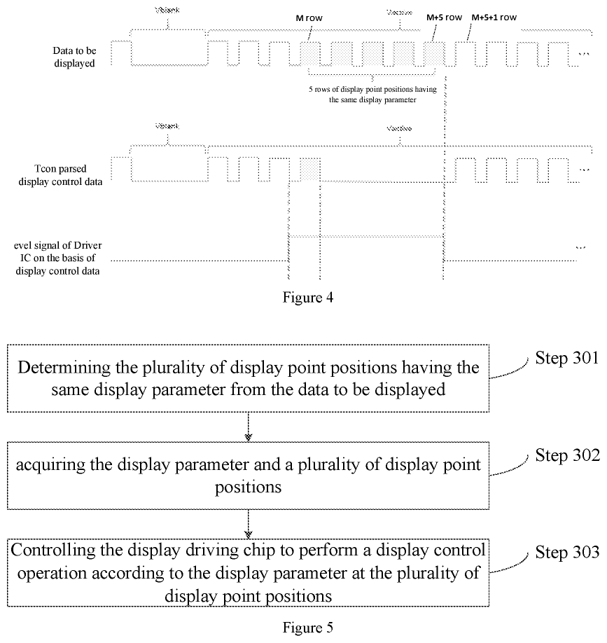

Further, in particular, in conjunction with the example described above with reference to FIG. 3, the method of the present embodiment may illustrate a specific implementation from a timing control logic, as shown in FIG. 4 below. It is assumed that, starting from the Mth line (the level signal of the first dark mark) in the data to be displayed, the content displayed by the display point positions of five consecutive rows is the same, i.e. They have the same display parameter. At this time, according to the method described in the present embodiment, after the Tcon receives the display control data, since the display control data records the display point positions corresponding to the same display parameter, the display parameter of these display point positions need not be all recorded, and only one is recorded (namely, the first high-level signal). At this time, when a level signal (the M−1)th line) before the Mth line is output, the control signal output to the Driver IC is pulled high, so as to inform the Driver IC that the point bit information that the display parameter is the same as the previous line will appear from the downstream. In this way, after receiving the control signal, the Driver IC will store the data of the Mth line into the memory area, and maintain the self-refresh output. Then the Tcon outputs the last level signal (the (M+5)th line) of the same data, the control signal is pulled low, so as to inform the Driver IC that the output of multiple display point positions with the same display parameter has been completed. Starting from the next line (namely, the (M+5+1)th line), it is required to perform real-time interactive communication with the Tcon for subsequent display control.

In addition, in the process that the acquisition unit transmits the display control data to the control unit on the basis of the display interval, transmission can actually be performed through the instruction of the screen logic board, and since the screen logic board needs to have timing logic in the process of performing display control to ensure the accuracy of the subsequent display effect, in the present embodiment, it is on the basis of this that the transmission process on the basis of the display interval is ensured to avoid the interference to the display process, so that the transmission process is transmitted within the time of every two frame image display interval, thereby avoiding the problem that the display effect is abnormal due to the timing problem of the display image.

Of course, in practice, this may be done on the basis of other transmission channels than the DP lines described in the examples above, without being limited thereto. In addition, in the above-mentioned example, when the device described in the present embodiment executes corresponding functions, various modules may be provided in a screen logic board. When the method described in the present embodiment is implemented, a program or module corresponding to the method may also be provided at the video card end or the display driving chip on the basis of the needs of a user, and this is not particularly limited and can be selected on the basis of the actual needs of the user.

Further, another embodiment of the present application also provides a display control method as an implementation of the method shown in FIGS. 1 and 2. This method embodiment corresponds to the foregoing method embodiment, and for ease of reading, the present device embodiment will not be described in detail with respect to the foregoing method embodiment, but it should be understood that the method of the present embodiment is capable of implementing all of the foregoing device embodiments. The method is applied to reduce power consumption in a display control process, and specifically as shown in FIG. 5, the method may include following steps.

Step 301, a plurality of display point positions having the same display parameter being determined from the data to be displayed.

The data to be displayed is acquired from a video card, and the data to be displayed comprises the plurality of display point positions and the display parameter corresponding to each of the display point positions.

Since it is likely that areas adjacent to each other in the image displayed later by the display have the same display content, for example, display units of adjacent rows may all display white. Therefore, when the plurality of display point positions with the same display parameter are determined in this step, it can also be determined in a certain manner on the basis of the characteristics of the imaging mode of the display apparatus, and the method of this step can be specifically as follows.

From the data to be displayed, the display point positions having the same display parameter in an adjacent area are determined in a target pattern.

In this way, in determining the plurality of display point positions with the same display parameter, the determination can be performed in a manner of adjacent positions or regions, and on the basis of the imaging characteristics of the display apparatus, when the video card generates data to be displayed, the data between the display point positions of adjacent areas are adjacent in sequence, which enables the confirmation to be performed more quickly when determining whether there is a display point position with the same display parameter between the display point positions of adjacent areas in the target pattern, thereby making the determination process faster.

Further, the determining the display point positions having the same display parameter in an adjacent area in a target pattern from the data to be displayed comprises:

according to a screen logic board, when the video card indicates that the data to be displayed exists, requesting the data to be displayed from the video card, and from the data to be displayed, determining the display point positions having the same display parameter in the adjacent area in the target pattern;

or

according to the video card, when it is detected that the video card indicates that the data to be displayed exists, acquiring the data to be displayed, and from the data to be displayed, determining the display point positions having the same display parameter in the adjacent area in the target pattern.

Further, the target pattern includes a row or column; the adjacent area includes an adjacent row or an adjacent column.

Since the target pattern comprises a row and a column, there are two manners of determining an adjacent row or an adjacent column respectively corresponding to the corresponding row and column, which can be respectively performed according to the following two aspects, specifically as follows.

On the one hand, there is a situation that the target pattern is a row and the adjacent area is an adjacent row.

In this step, the determining the display point positions having the same display parameter in the adjacent area in the target pattern from the data to be displayed, when executed, may be:

from the data to be displayed, determining the plurality of display point positions having the same display parameter from the adjacent row by rows.

The imaging method on the basis of the current display apparatus generally displays the display point positions of each row in sequence by means of rows, and therefore, in this step, whether the plurality of display point positions between two adjacent rows have the same display parameter is respectively judged by means of rows, thereby realizing the judgement of the plurality of display point positions with the same display parameter by means of rows.

On the other hand, there is a situation that the target pattern is a column and the adjacent area is an adjacent row and column.

When the display apparatus performs image display on the basis of columns, the judgement can be performed on the basis of columns according to the method described in this step, that is to say, which columns are all present in the display point positions having the same display parameter are determined from adjacent columns by columns.

On the basis of this, in the present step, from the data to be displayed, the display point positions having the same display parameter in the adjacent area is determined in the target pattern, and when executed, it can be specifically:

from the data to be displayed, determining the plurality of display point positions having the same display parameter from adjacent columns in columns.

On the basis of the methods described in the above-mentioned two aspects, the method described in the embodiment of the present application can ensure that the imaging mode of the display apparatus can be determined in a row or column manner in accordance with the imaging mode of the display apparatus when determining the display point positions with the same display parameter, so as to ensure that the imaging characteristics of the display apparatus are satisfied in the subsequent display control process. Thus, the device described in the present embodiment has all the units described in the embodiment of the first aspect, that is to say, the interaction process between the screen logic board and the display driving chip can also be reduced, and the functions of the above-mentioned units or modules in the present embodiment also exist, which not only reduces the power consumption of the interaction process between the screen logic board and the display driving chip, but also ensures the accuracy of the display control effect. At the same time, the determination on the basis of the manner of adjacent rows or adjacent columns can also ensure that the determination can be performed in a certain order during the determination of the display point positions having the same display parameter, so as to avoid the deviation of the subsequent display control effect caused by the disorder of the order, thereby improving the accuracy of the display control effect.

Step 302. acquiring the display parameter and the plurality of display point positions.

In an embodiment of the present application, the process of acquiring the display parameter and the plurality of display point positions may be specifically as follows: packing the display parameter and the plurality of display point positions via the screen logic board to obtain display control data, and transmitting the display control data.

When the display parameter and the display point positions are acquired, the display parameter and the display point positions can be transmitted to a subsequent display driving chip which performs a display control operation. In order to ensure the transmission efficiency and reduce the problem of data loss which may be caused by the transmission process, in the embodiment of the present application, the display parameter and the corresponding plurality of display point positions can be firstly packaged on the basis of the method of the present step to obtain display control data, so that the display control data can be transmitted in the subsequent transmission process.

After acquiring the display control data, the display control data can be transmitted to the display driving chip via a preset protocol.

The preset protocol comprises a P2P protocol and a BT protocol.

Since the method described in this embodiment is to reduce the power consumption of the display control process, the display control data obtained in the previous step 302 can be sent to the display driving chip at once in this step, so that the display driving chip can perform display control on the display apparatus using only the received display control data in the subsequent display control process. In order to improve transmission efficiency, a P2P or BT protocol is generally used in this embodiment.

Furthermore, in practical applications, since the display process is actually performed frame by frame, in order to avoid the influence of the process of transmitting display control data on the display process, the process of transmitting display control data between every two frames of images can also be performed as follows.

Firstly, a display interval between each frame of images is determined, wherein the display interval is used for characterizing a time interval between the last one of the display point positions in the m frame of image to the first one of the display point positions in the m+1 frame of image displayed by a display apparatus, wherein m is a positive integer;

The display control data is then transmitted on the basis of the display interval.

Step 303. controlling the display driving chip to perform a display control operation according to the display parameter at the plurality of display point positions.

Specifically, this step can be performed as follows: receiving the display control data, parsing the display control data into the display parameter and the plurality of display point positions, and controlling the display driving chip to display sequentially at the plurality of display point positions on the basis of the display parameter.

The display control data is obtained on the basis of the fact that the plurality of display point positions having the same display parameter and the display parameter have been packaged in the previous step, and therefore, before the display control is finally performed, the packaged display control data also needs to be parsed and restored to the display point positions and the display parameter corresponding to the display point positions. It needs to be stated that in the parsing process, parsing can be performed by the screen logic board, that is to say, when performing display control, a display driving chip can transmit a request instruction to be parsed by the screen logic board to obtain the display point positions and the corresponding display parameter. Of course, a parsing instruction may be built in the display driving chip in advance, and the display driving chip may parse itself when receiving the display control data. The specific operation situation is not specifically defined herein, and can be selected by a user on his own initiative on the basis of actual requirements.

Furthermore, when this step is specifically performed as follows.

After acquiring the display parameter, a starting point position and an ending point position in the plurality of display point positions are determined, and the display parameter in a preset memory area is retained, and a signal adjustment command is output to the display driving chip according to the starting point position and the ending point position.

The signal adjustment command is used for controlling the display driving chip to adjust from a first level to a second level from the starting point position until the second level is restored to the first level after display from the starting point position to the ending point position according to the display parameter in the preset memory area.

In order to achieve the above-mentioned object, according to another aspect of the present application, embodiments of the present application further provide a memory medium including a stored program, wherein an apparatus on which the memory medium is located is controlled to execute the display control method described above when the program is run.

In order to achieve the above-mentioned object, according to another aspect of the present application, embodiments of the present application further provide a display control device including a memory medium; and one or more processors, the memory medium being coupled to the processors, the processors being configured to execute program instructions stored in the memory medium, the program instructions when executed performing the display control method described above.

The embodiments of the present application provide a display control device, method and apparatus. The present application can determine a plurality of display point positions having the same display parameter from data to be displayed by a determination unit, then acquire the display parameter and the plurality of display point positions by an acquisition unit, and finally control a display driving chip to perform a display control operation according to the display parameter at the plurality of display point positions by a control unit. The data to be displayed can be acquired from the video card, and the data to be displayed comprises the plurality of display point positions and the display parameter corresponding to each of the display point positions, that is to say, the display driving chip does not need to acquire the data to be displayed in real time during a display control operation, which ensures that in the process of subsequent display control, the display control function can be realized only by means of the display driving chip itself, without any communication and interaction with the video card or even the screen logic board, so that when there are a plurality of display point positions having the same display parameter in the data to be displayed, there is no need for the above-mentioned communication interaction process among the video card, the screen logic board and the display driving chip, and since the control unit can directly perform display control on the basis of the acquired display parameter and display point positions in the display control process, the communication channel among the screen logic board, the video card and the display driving chip can be closed, thereby reducing the power consumption influence caused by the communication interaction, especially when there are more display point positions with the same display parameter in the data to be displayed. The power consumption occupation situation caused by the communication interaction can be greatly reduced. The effect of reducing power consumption in the display control process is achieved.

The display control device comprises a processor and a memory, the above-mentioned determination unit, acquisition unit, control unit, etc. are all stored in the memory as a program unit, and the processor executes the above-mentioned program unit stored in the memory to realize corresponding functions.

The processor comprises a core, and the core calls a corresponding program unit from a memory. The core may have one or more settings to reduce power consumption during display control by adjusting core parameter.

An embodiment of the present application provides a display control apparatus, the apparatus comprising a memory medium; and one or more processors, the memory medium being coupled to the processors, the processors being configured to execute program instructions stored in the memory medium, the program instructions when executed performing the display control method of any of the preceding claims.

An embodiment of the present application provides a memory medium including a stored program, wherein an apparatus in which the memory medium is located is controlled to execute the above-described display control method when the program is run.

The memory medium may comprise a form of non-persistent memory, random access memory (RAM), and/or non-volatile memory, such as read only memory (ROM) or flash memory (flash RAM), in a computer readable medium, the memory comprising at least one memory chip.

An embodiment of the present application provides an apparatus, the apparatus comprising a processor, a memory and a program stored in the memory and executable on the processor, wherein when the processor executes the program, the following steps are implemented: determining a plurality of display point positions having the same display parameter from data to be displayed, wherein the data to be displayed comprises the plurality of display point positions and the display parameter corresponding to each of the display point positions; acquiring the display parameter and the plurality of display point positions; controlling the display driving chip to perform a display control operation according to the display parameter at the plurality of display point positions, so that the display driving chip does not need to acquire the data to be displayed in real time during the display control operation.

Further, the determining the plurality of display point positions having the same display parameter from the data to be displayed comprises:

acquiring the data to be displayed from a video card, and determining the display point positions having the same display parameter in an adjacent area in a target pattern from the data to be displayed.

Further, the determining the display point positions having the same display parameter in an adjacent area in a target pattern from the data to be displayed comprises:

when the video card indicates that the data to be displayed exists, requesting the data to be displayed from the video card, and determining the display point positions having the same display parameter in the adjacent area in the target pattern from the data to be displayed;

or

when it is detected that the video card indicates that the data to be displayed exists, acquiring the data to be displayed and determining the display point positions having the same display parameter in the adjacent area in the target pattern from the data to be displayed.

Further, the target pattern includes a row or column, and the adjacent area comprises an adjacent row or an adjacent column; and

when the video card indicates that the data to be displayed exists, requesting the data to be displayed from the video card, and determining the display point positions having the same display parameter in the adjacent area in the target pattern from the data to be displayed comprises:

when the target pattern is a row and the adjacent area is an adjacent row, determining the plurality of display point positions having the same display parameter from the data to be displayed from adjacent rows by rows; or

when the target pattern is a column and the adjacent area is an adjacent column, determining the plurality of display point positions having the same display parameter from the data to be displayed from adjacent columns by columns.

Further, the acquiring the display parameter and the plurality of display point positions comprises: packing the display parameter and the plurality of display point positions to obtain display control data, and transmitting the display control data.

The control display driving chip performing a display control operation according to the display parameter at the plurality of display point positions comprises:

receiving the display control data, parsing the display control data into the display parameter and the plurality of display point positions, and controlling the display driving chip to display sequentially at the plurality of display point positions on the basis of the display parameter.

Further, the receiving the display control data, parsing the display control data into the display parameter and the plurality of display point positions, and controlling the display driving chip to display sequentially at the plurality of display point positions on the basis of the display parameter comprises:

after acquiring the display parameter, determining a starting point position and an ending point position in the plurality of display point positions, and retaining the display parameter in a preset memory area, and outputting a signal adjustment command to the display driving chip according to the starting point position and the ending point position,

the signal adjustment command being used for controlling the display driving chip to adjust from a first level to a second level from the starting point position until the second level is restored to the first level after display from the starting point position to the ending point position according to the display parameter in the preset memory area.

Further, the method further comprises:

determining a display interval between each frame of image from the display driving chip, wherein the display interval is used for characterizing a time interval between displaying the last one of the display point positions in the m frame of image to the first one of the display point positions in the (m+1)th frame of image by the display apparatus, wherein m is a positive integer; transmitting the display control data on the basis of the display interval.

The present application also provides a computer program product adapted to execute, when executed on a data processing apparatus, program code for initializing the following method steps: determining a plurality of display point positions having the same display parameter from data to be displayed, wherein the data to be displayed comprises the plurality of display point positions and the display parameter corresponding to each of the display point positions; acquiring the display parameter and the plurality of display point positions; controlling the display driving chip to perform a display control operation according to the display parameter at the plurality of display point positions, so that the display driving chip does not need to acquire the data to be displayed in real time during the display control operation.

Those skilled in the art will appreciate that embodiments of the present application can be provided as a method, system, or computer program product. Accordingly, this application may take the form of an entirely hardware embodiment, an entirely software embodiment or an embodiment combining software and hardware aspects. Moreover, the present application can take the form of a computer program product embodied on one or more computer-usable memory medium (including, but not limited to, magnetic disk storage, CD-ROM, optical storage, etc.) having computer-usable program code embodied therein.

The present application is described with reference to flowchart illustrations and/or block diagrams of methods, apparatus (systems), and computer program products according to embodiments of the present application. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create device for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction device which implement the function specified in the flowchart flow or flows and/or block diagram block or blocks.

These computer program instructions may also be loaded onto a computer or other programmable data processing apparatus to cause a series of operational steps to be performed on the computer or other programmable apparatus to produce a computer implemented process such that the instructions executed on the computer or other programmable apparatus provide steps for implementing the functions specified in the flowchart flow or flows and/or block diagram block or blocks.

In a typical configuration, a computing apparatus includes one or more processors CPU, input/output interfaces, network interfaces, and memory.

The memory may include forms of non-persistent memory, random access memory (RAM), and/or non-volatile memory, such as read only memory (ROM) or flash memory (flash RAM), in a computer readable medium. Memory is an example of a computer readable medium.

Computer readable medium, including both permanent and non-permanent, removable and non-removable media, can implement information storage by any method or technology. The information may be computer readable instructions, data structures, modules of a program, or other data. Examples of memory medium for a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, tape magnetic disk storage or other magnetic storage apparatuses or any other non-transmission medium, which may be used to store information that may be accessed by a computing apparatus. As defined herein, a computer readable medium does not include a transitory media, such as a modulated data signal and a carrier wave.

It should also be noted that the terms “comprises”, “comprising”, or any other variation thereof, are intended to cover a non-exclusive inclusion, such that a process, method, article, or apparatus that comprises a list of elements not only includes those elements but may include other elements not expressly listed or inherent to such process, method, article, or apparatus. An element proceeded by the phrase “comprising a” does not, without more constraints, preclude the existence of additional identical elements in the process, method, article, or apparatus that comprises the element.

Those skilled in the art will appreciate that embodiments of the present application can be provided as a method, system, or computer program product. Accordingly, this application may take the form of an entirely hardware embodiment, an entirely software embodiment or an embodiment combining software and hardware aspects. Moreover, the present application can take the form of a computer program product embodied on one or more computer-usable memory medium (including, but not limited to, magnetic disk storage, CD-ROM, optical storage, etc.) having computer-usable program code embodied therein.

The foregoing is by way of example only and is not intended as limiting. It will be apparent to those skilled in the art that various modifications and variations can be made in the present application. Any modifications, equivalents, improvements, etc. that come within the spirit and principle of the present application fall within the scope of the claims of the present application.

1. A display control device, comprising:
a determination unit for determining a plurality of display point positions having a same display parameter from data to be displayed, the data to be displayed comprising the plurality of display point positions and the display parameter corresponding to each of the display point positions;
an acquisition unit for acquiring the display parameter and the plurality of display point positions; and
a control unit for controlling a display driving chip to perform a display control operation according to the display parameter at the plurality of display point positions, so that the display driving chip does not need to acquire the data to be displayed in real time during the display control operation.

2. The device according to claim 1, wherein
the determination unit is specifically used for acquiring the data to be displayed from a video card, and determining the display point positions having the same display parameter in an adjacent area in a target pattern from the data to be displayed.

3. The device according to claim 2, wherein the determination unit comprises: a first determination module or a second determination module,
the first determination module being arranged in a screen logic board for, when the video card indicates that the data to be displayed exists, requesting the data to be displayed from the video card, and determining the display point positions having the same display parameter in the adjacent area in the target pattern from the data to be displayed; and
the second determination module being provided in the video card for, when it is detected that the video card indicates that the data to be displayed exists, acquiring the data to be displayed, and determining the display point positions having the same display parameter in the adjacent area in the target pattern from the data to be displayed.

4. The device according to claim 3, wherein the target pattern comprises a row or column; and the adjacent area comprises an adjacent row or an adjacent column,
the first determination module also specifically comprising: a first determination submodule or a second determination submodule,
the first determination submodule being used for, when the target pattern is a row and the adjacent area is an adjacent row, determining the plurality of display point positions having the same display parameter from the data to be displayed from adjacent rows by rows; and
the second determination submodule being used for, when the target pattern is a column and the adjacent area is an adjacent column, determining the plurality of display point positions having the same display parameter from the data to be displayed from adjacent columns by columns.

5. The device according to claim 1, wherein
the acquisition unit is arranged on the screen logic board, and is further used for packaging the display parameter and the plurality of display point positions to obtain display control data, and transmitting the display control data to the control unit; and
the control unit is further used for receiving the display control data, parsing the display control data into the display parameter and the plurality of display point positions, and controlling the display driving chip to display sequentially at the plurality of display point positions on the basis of the display parameter.

6. The device according to claim 5, wherein the control unit is provided to the display driving chip,
the control unit being further used for, after acquiring the display parameter, determining a starting point position and an ending point position at the plurality of display point positions, retaining the display parameter in a preset memory area, and outputting a signal adjustment command to the display driving chip according to the starting point position and the ending point position; and
the signal adjustment command being used for controlling the display driving chip to adjust from a first level to a second level from the starting point position until the second level is restored to the first level after display from the starting point position to the ending point position according to the display parameter in the preset memory area.

7. The device according to claim 5, further comprising:
a transmission adjustment unit used for determining a display interval between each frame of images from the display driving chip, and transmitting the display interval to the acquisition unit, the display interval being used for characterizing a time interval from a last one of the display point positions in an m frame of image to a first one of the display point positions in an m+1 frame of image displayed by a display apparatus, and m being a positive integer,
the acquisition unit being further configured to transmit the display control data to the control unit on the basis of the display interval.

8. A display control method, comprising:
determining a plurality of display point positions having a same display parameter from data to be displayed, the data to be displayed comprising the plurality of display point positions and the display parameter corresponding to each of the display point positions;
acquiring the display parameter and the plurality of display point positions; and
controlling a display driving chip to perform a display control operation according to the display parameter at the plurality of display point positions, so that the display driving chip does not need to acquire the data to be displayed in real time during the display control operation.

9. The method according to claim 8, wherein the determining a plurality of display point positions having a same display parameter from data to be displayed comprises:
acquiring the data to be displayed from a video card, and determining the display point positions having the same display parameter in an adjacent area in a target pattern from the data to be displayed.

10. The method according to claim 9, wherein the determining the display point positions having the same display parameter in an adjacent area in a target pattern from the data to be displayed comprises:
when the video card indicates that the data to be displayed exists, requesting the data to be displayed from the video card, and determining the display point positions having the same display parameter in the adjacent area in the target pattern from the data to be displayed,
or
when it is detected that the video card indicates that the data to be displayed exists, acquiring the data to be displayed, and determining the display point positions having the same display parameter in the adjacent area in the target pattern from the data to be displayed.

11. The method according to claim 10, wherein the target pattern comprises a row or column; and the adjacent area comprises an adjacent row or an adjacent column,
when the video card indicates that the data to be displayed exists, requesting the data to be displayed from the video card, and determining the display point positions having the same display parameter in the adjacent area in the target pattern from the data to be displayed comprises:
when the target pattern is a row and the adjacent area is an adjacent row, determining the plurality of display point positions having the same display parameter from the data to be displayed from adjacent rows by rows; and
when the target pattern is a column and the adjacent area is an adjacent column, determining the plurality of display point positions having the same display parameter from the data to be displayed from adjacent columns by columns.

12. The method according to claim 8, wherein the acquiring the display parameter and the plurality of display point positions comprises:
packaging the display parameter and the plurality of display point positions to obtain display control data, and transmitting the display control data to the control unit; and
the controlling a display driving chip to perform a display control operation according to the display parameter at the plurality of display point positions comprises:
receiving the display control data, parsing the display control data into the display parameter and the plurality of display point positions, and controlling the display driving chip to display sequentially at the plurality of display point positions on the basis of the display parameter.

13. The method according to claim 12, wherein the receiving the receiving the display control data, parsing the display control data into the display parameter and the plurality of display point positions, and controlling the display driving chip to display sequentially at the plurality of display point positions on the basis of the display parameter comprises:
after acquiring the display parameter, determining a starting point position and an ending point position in the plurality of display point positions, retaining the display parameter in a preset memory area, and outputting a signal adjustment command to the display driving chip according to the starting point position and the ending point position; and
the signal adjustment command being used for controlling the display driving chip to adjust from a first level to a second level from the starting point position until the second level is restored to the first level after display from the starting point position to the ending point position according to the display parameter in the preset memory area.

14. The method according to claim 12, further comprising:
determining a display interval between each frame of images from the display driving chip, the display interval being used for characterizing a time interval from a last one of the display point positions in an m frame of image to a first one of the display point positions in an (m+1)th frame of image displayed by a display apparatus, and m being a positive integer; and
transmitting the display control data on the basis of the display interval.

15. A display control apparatus, comprising: a memory medium; and one or more processors, the memory medium being coupled to the processors, the processors being configured to execute program instructions stored in the memory medium, the program instructions when executed perform the display control method according to claim 8.
